(19) United States
(12) Patent Application Publication
(10) Pub. No.: US 2026/0316610 A1
(43) Pub. Date: Oct. 15, 2026

(54) POWER INTERCHANGE PLANNING APPARATUS, POWER INTERCHANGE PLANNING METHOD, AND PROGRAM

(71) Applicant: NTT, Inc., Tokyo (JP)

(72) Inventors: Miho IWAMOTO, Tokyo (JP); Motoki SUWABE, Tokyo (JP); Masaki KOZAI, Tokyo (JP); Hiroya MINAMI, Tokyo (JP); Toru TANAKA, Tokyo (JP)

(21) Appl. No.: 19/485,480

(22) PCT Filed: May 29, 2023
(86) PCT No.: PCT/JP2023/019951

§ 371 Date: Nov. 18, 2025

(51) Int. Cl. B60L 53/51; B60L 53/62; B60L 53/63; B60L 53/66; B60L 55/00

(52) U.S. Cl. CPC B60L 53/51; B60L 53/62; B60L 53/63; B60L 53/66; B60L 55/00; B60L 2240/547; B60L 2240/662; B60L 2240/68

(57) ABSTRACT

A power interchange planning apparatus that creates a plan for performing power interchange among a plurality of electric mobile devices, the power interchange planning apparatus including: a use schedule acquisition unit that acquires a use schedule of each of the electric mobile devices; and a plan creation unit that calculates a future power consumption amount of each of the electric mobile devices based on the use schedule, and creates a power interchange plan among the plurality of electric mobile devices based on the power consumption amount and an amount of power stored in each of the electric mobile devices.

### TECHNICAL FIELD

The present invention relates to a technology for performing power interchange among electronic vehicles (EVs).

### BACKGROUND ART

In order to effectively utilize renewable energy (for example, photovoltaic power generation (PV)), an off-grid type EV charging station (in the state of not being connected to a power supply network of an electric power company) using a solar car port as a power source has been introduced. However, PV can generate power only during the day, and thus an EV arriving at the solar car port at night cannot be charged with power of PV. Therefore, it is generally necessary to charge EVs with power from a system.

There is a known technology in which, in a case where there are two or more EVs in a solar car port, power is transferred (supplied) from an EV charged by PV during the day to an EV having arrived at night to enable an improvement in the renewable energy utilization rate without using power from a system (Non-Patent Literatures 1 and 2).

### CITATION LIST

### Non-Patent Literature

Non-Patent Literature 1: HIOKI E. E. CORPORATION and Yanekara Inc. start demonstration of off-grid EV charging system utilizing V2V charging technology https://prtimes.jp/main/html/rd/p/000000005.000067381.html
Non-Patent Literature 2: Solar charging and discharging system for EV/ordinary charging outlet for EV capable of power peak cutting with optimal charging and discharging control https://www.nedo.go.jp/content/100953986.pdf

### SUMMARY OF INVENTION

### Technical Problem

In power interchange among EVs, it is necessary to interchange power so as not to hinder the use of an EV on the power supply side. However, no technology has been established for creating an interchange plan, such as how much power should be transferred from one EV to another EV. For example, in a case where power is interchanged such that the sum of the amount of remaining power (for example, state of charge (SOC)) of all EVs staying in a solar car port is divided to give an equal SOC to each of the EVs, an EV may be short of power.

The present invention has been made in view of the above points, and an object thereof is to provide a technology for performing power interchange among EVs with as little trouble as possible in the use of the EVs.

### Solution to Problem

According to the disclosed technology, there is provided a power interchange planning apparatus that creates a plan for performing power interchange among a plurality of electric mobile devices, the power interchange planning apparatus including:
a use schedule acquisition unit that acquires a use schedule of each of the electric mobile devices; and
a plan creation unit that calculates a future power consumption amount of each of the electric mobile devices based on the use schedule, and creates a power interchange plan among the plurality of electric mobile devices based on the power consumption amount and an amount of power stored in each of the electric mobile devices.

### Advantageous Effects of Invention

According to the disclosed technology, there is provided a technology for performing power interchange among EVs with as little trouble as possible in the use of the EVs.

### BRIEF DESCRIPTION OF DRAWINGS

FIG. 1 is a diagram illustrating a configuration example of an inter-EV power interchange system according to the present embodiment.

FIG. 2 is a flowchart for describing an operation example of a power interchange planning apparatus 100.

FIG. 3 is a diagram illustrating an example of interchange policies.

FIG. 4 is a diagram illustrating an example of use schedule information.

FIG. 5 is a diagram illustrating a use schedule image.

FIG. 6 is a diagram illustrating an example of an interchange plan.

FIG. 7 is a diagram illustrating a configuration example of the power interchange planning apparatus 100.

FIG. 8 is a diagram illustrating a hardware configuration example of the power interchange planning apparatus 100.

### DESCRIPTION OF EMBODIMENTS

Hereinafter, an embodiment of the present invention (present embodiment) will be described with reference to the drawings. The embodiment to be described below is merely an example, and embodiments to which the present invention is applied are not limited to the following embodiment.

In the following description, power interchange is performed among EVs. The EVs may be referred to as electric mobile devices. The present embodiment assumes that the EVs are automobiles used for business, but the EVs are not limited to automobiles. The EVs may be agricultural machines, motorcycles, work vehicles (forklifts), ships, airplanes, or the like.

In addition, in the example described below, a use schedule for the next day of the plan creation date is used as a use schedule, but this is an example. The use schedule is not limited to the use schedule for the next day.

### Outline of Embodiment

The present embodiment assumes a situation in which one or more EVs are used. Each EV is placed in a solar car port having a PV device while not being used, and is charged by PV during the day. Power interchange is performed among two or more EVs placed in the solar car port when charging by PV cannot be performed, such as at night.

Specifically, first, a power interchange planning apparatus 100 sets an interchange policy based on a use schedule of each EV for the next day. The interchange policy is a policy on how to interchange power among two or more EVs. Parameters and calculation methods used for calculation in the creation of an interchange plan are determined according to the interchange policy.

The power interchange planning apparatus 100 calculates, for each EV, an SOC (corresponding to a power consumption amount P) necessary for the next day from a reference parameter (which is a parameter based on the interchange policy, and is, for example, a distance L from a departure point to a destination on the next day) obtained from the use schedule for the next day. For example, the SOC necessary for the next day may be calculated by “distance L/electrical efficiency d” using the electrical efficiency as a catalog value of the EV, or the SOC necessary for the next day may be calculated from a past history.

The power interchange planning apparatus 100 creates a plan for interchanging power among the EVs according to the calculation result of the SOC necessary for each EV for the next day, and performs interchange based on the plan.

For example, the power interchange planning apparatus 100 may calculate the total amount of the SOC (amount of stored power) of all the EVs belonging to the solar car port, and create a plan of power distribution among the EVs on the basis of the total amount. In accordance with this plan, the power interchange planning apparatus 100 performs power interchange among the EVs so as not to affect the mobility use on the next day. For example, an EV that is not scheduled to be used on the next day may discharge power until the SOC is 0%.

With the above processing, it is possible to interchange power among the EVs without affecting the mobility of each EV, and it is possible to maximize the renewable energy utilization rate.

### (Regarding Optional Function)

As a parameter corresponding to the interchange policy, not only the reference parameter but also a parameter for adding a margin, such as an SOC fluctuation parameter, may be added.

The SOC fluctuation parameter is a parameter for reflecting fluctuation of a future power consumption amount of an EV (which may be referred to as uncertainty of a calculated value of the power consumption amount) in the calculated power consumption amount.

For example, the SOC fluctuation parameter is a value proportional to the distance L to the destination or a coefficient (coefficient of proportionality) by which the distance L is multiplied. For example, by using the SOC fluctuation parameter for calculating (estimating) an SOC necessary for an EV for the next day, the power interchange planning apparatus 100 can estimate the margin of the SOC necessary for the next day to be small in a case where the distance to the destination is short, and can estimate the margin of the SOC necessary for the next day to be large in a case where the distance to the destination is long.

It is considered that the margin of the SOC necessary for the next day, which is calculated from “distance/electrical efficiency”, changes depending on the environment during the travel of the EV. Therefore, the power interchange planning apparatus 100 may use a different value depending on the environment during the travel of the EV as an SOC fluctuation parameter. Examples of the environment during the travel of the EV include whether there is traffic congestion, whether an air conditioner is used, whether a highway is used, a road situation such as inclination, a route, and the like.

For example, in a case where the temperature of the next day is predicted to be 30° C. or higher by a weather forecast or the like, and the information (=the temperature of the next day is 30° C. or higher) is acquired, the power interchange planning apparatus 100 determines that the air conditioner is to be used when the EV is used on the next day, and adds a margin larger than a margin in a case where the air conditioner is not used to the power consumption amount for the next day, which is calculated from, for example, “distance/electrical efficiency”.

The power interchange planning apparatus 100 can determine the margin corresponding to the fluctuation of the Soc by using at least one or more pieces of information among a plurality of pieces of information obtained from the use schedule for the next day. The plurality of pieces of information obtained from the use schedule for the next day include, for example, the destination, the distance to the destination (which can be estimated from an existing navigation system), the scheduled departure time, the scheduled arrival time, and the travel time (the difference between the reservation time and the required time, or time that can be estimated from the scheduled departure (arrival) time by the existing navigation system). Hereinafter, the configuration and operation of a system/device according to the present embodiment will be described in detail.

### (System Configuration Example)

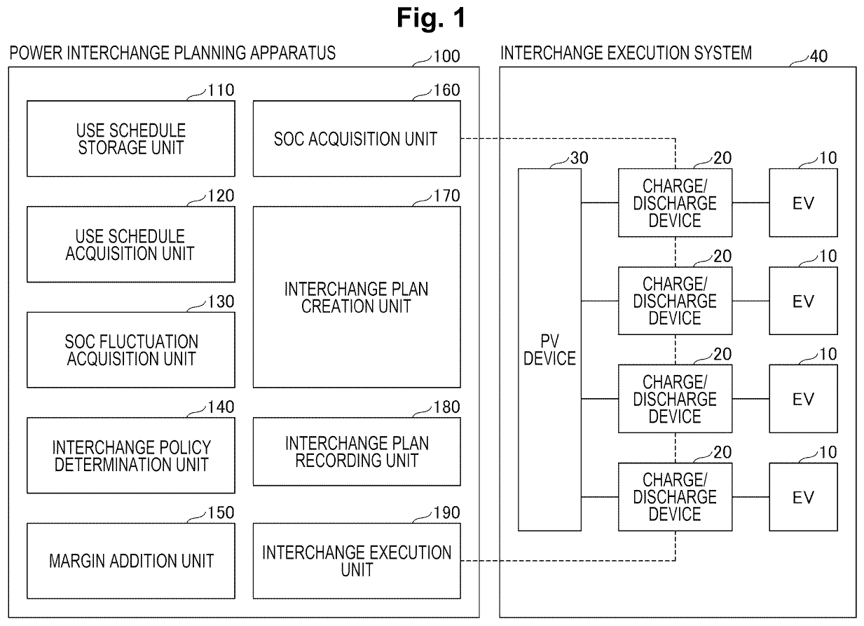

FIG. 1 illustrates a configuration example of an inter-EV power interchange system according to the present embodiment. As illustrated in FIG. 1, the inter-EV power interchange system according to the present embodiment includes the power interchange planning apparatus 100 and an interchange execution system 40.

The interchange execution system 40 includes a PV device 30 and one or more charge/discharge devices 20. EVs 10 can be connected to the charge/discharge devices 20. The charge/discharge devices 20 supply power generated by the PV device 30 to the EVs 10. In addition, the charge/discharge devices 20 can perform power interchange among the EVs 10 on the basis of an instruction from the power interchange planning apparatus 100. Note that a configuration in which the plurality of EVs 10 is connected to one charge/discharge device 20 may be adopted.

The power interchange planning apparatus 100 includes a use schedule storage unit 110, a use schedule acquisition unit 120, an SOC fluctuation acquisition unit 130, an interchange policy determination unit 140, a margin addition unit 150, an SOC acquisition unit 160, an interchange plan creation unit 170, an interchange plan recording unit 180, and an interchange execution unit 190.

Note that the power interchange planning apparatus 100 need not include the interchange execution unit 190. For example, another device including the interchange execution unit 190 may be notified of an interchange plan created by the power interchange planning apparatus 100.

### (Operation Example of Power Interchange Planning Apparatus 100)

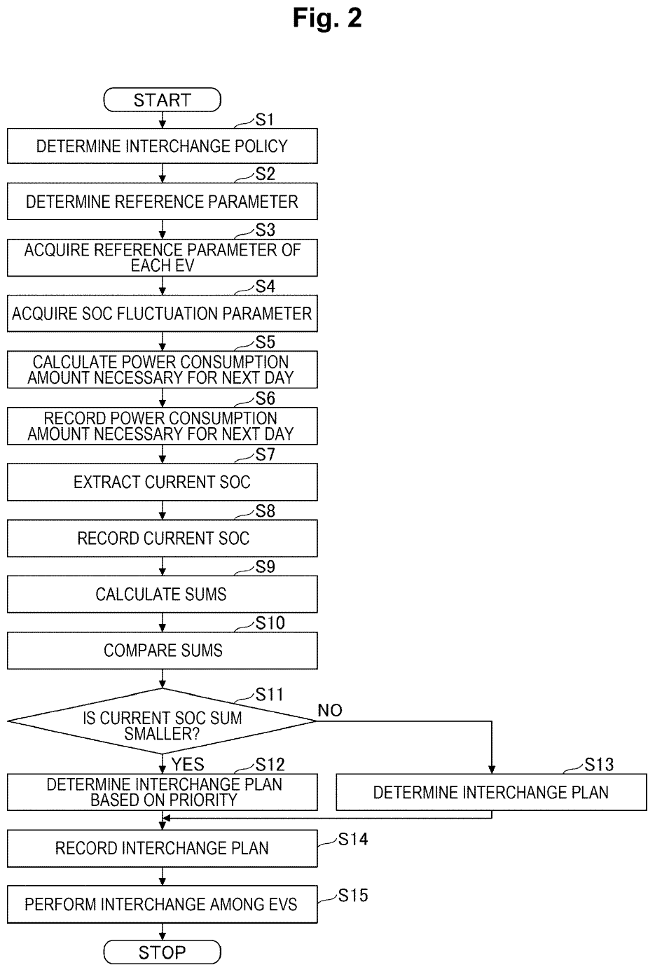

Next, an operation example of the power interchange planning apparatus 100 will be described along the procedure of the flowchart of FIG. 2.

### <S1, S2>

In S1, the interchange policy determination unit 140 determines an interchange policy. The determined interchange policy is passed to the interchange plan creation unit 170. The interchange policy determination unit 140 may determine the interchange policy on the basis of an instruction from a user or may automatically determine the interchange policy.

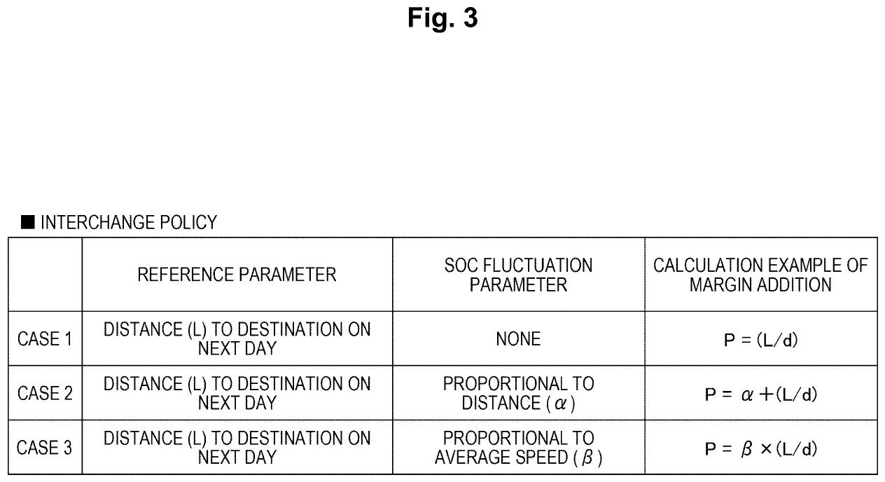

FIG. 3 illustrates an example of three interchange policies. In the example of FIG. 3, in all cases 1 to 3, the distance (L) to the destination on the next day is used as a reference parameter. As an SOC fluctuation parameter, “none” is used in the case 1, a value proportional to the distance is used in the case 2, and a value proportional to the average speed is used in the case 3.

For example, a plurality of interchange policies as illustrated in FIG. 3 may be stored in a storage device such as a memory in the power interchange planning apparatus 100, and the interchange policy determination unit 140 may select one interchange policy from the plurality of interchange policies.

The present embodiment assumes that the case 2 is determined as an interchange policy. That is, in the present embodiment, the description will be made assuming that the power consumption amount necessary for each EV for the next day is calculated by a margin corresponding to the distance to the destination being added to the power consumption amount calculated from the distance.

In S2, the interchange plan creation unit 170 determines to set “the distance to the destination on the next day” as a reference parameter on the basis of the determined interchange policy.

### <S3>

In S3, the use schedule acquisition unit 120 acquires the reference parameter (value of the reference parameter) of each of the EVs 10 from the use schedule storage unit 110. Here, the use schedule acquisition unit 120 acquires the distance to the destination on the next day for all the EVs 10 from the use schedule storage unit 110. The acquired information is passed to the interchange plan creation unit 170.

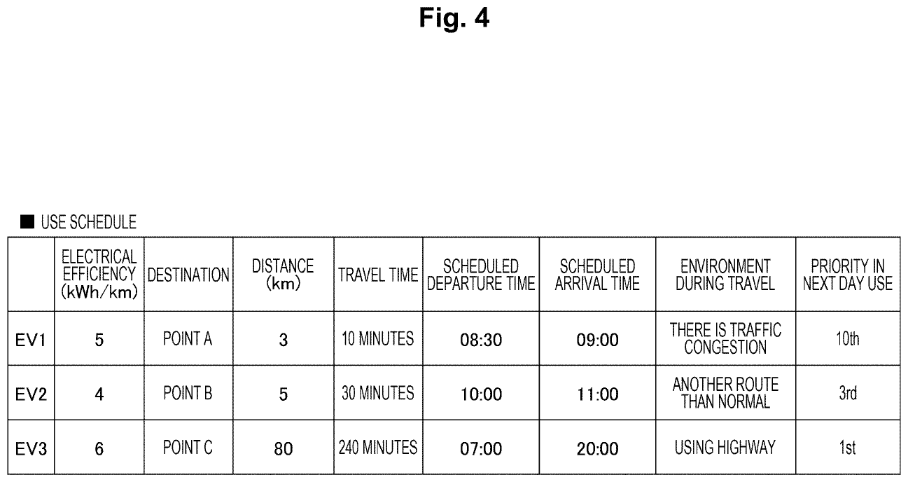

FIG. 4 illustrates an example of use schedule information of an EV 1 to an EV 3 stored in the use schedule storage unit 110. FIG. 4 illustrates a use schedule for the next day, on the day of the interchange plan creation time point (for example, a time point after arrival of all EVs on a given day).

As illustrated in FIG. 4, in this example, “priority in next day use” is included in the use schedule. In the example of FIG. 4, the EV 3 has the highest priority.

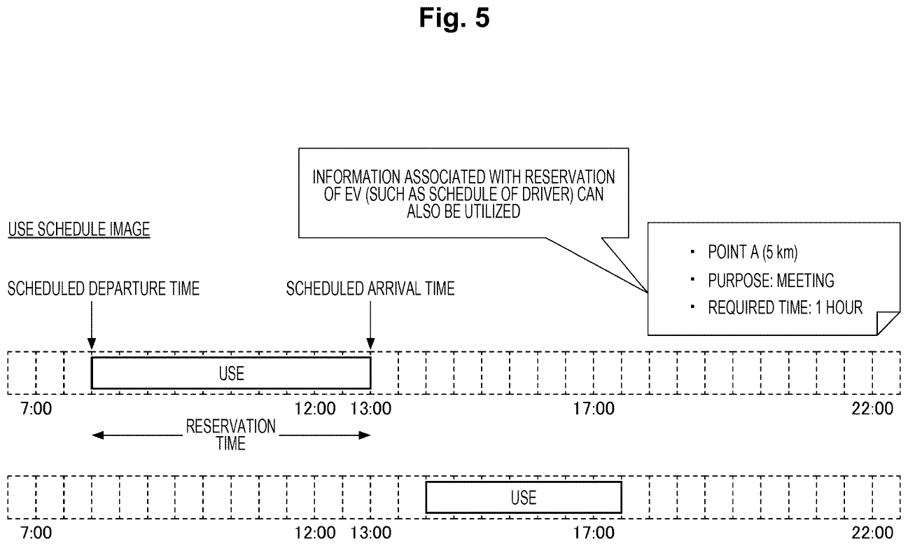

FIG. 5 illustrates a use schedule (also referred to as a reservation) on the time axis (use schedule image). As illustrated in FIG. 5, in addition to a reservation of an EV itself, information associated with the reservation may be utilized.

### <S4>

In S4 of FIG. 2, the SOC fluctuation acquisition unit 130 acquires an SOC fluctuation parameter on the basis of the interchange policy determined by the interchange policy determination unit 140. The acquired SOC fluctuation parameter is passed to the interchange plan creation unit 170.

Here, the SOC fluctuation parameter is a parameter that increases the margin as the distance to the destination is longer and decreases the margin as the distance to the destination is shorter. For example, assuming that the fluctuation (margin) is proportional to the distance, the SOC fluctuation acquisition unit 130 acquires a coefficient α that is a coefficient of proportionality to the distance. The SOC fluctuation acquisition unit 130 may acquire the coefficient α from the interchange policy determination unit 140, or the user may designate the coefficient α for the SOC fluctuation acquisition unit 130. The SOC fluctuation parameter may be a margin value itself instead of a coefficient.

### <S5, S6>

In S5, for each of the EVs 10, the margin addition unit 150 adds a value (margin), obtained by multiplying the distance to the destination on the next day acquired in S3 by the coefficient α, to a value calculated by, for example, “distance/electrical efficiency” (L/d), thereby calculating the power consumption amount necessary for the next day.

In S6, the power consumption amount required by each of the EVs 10 for the next day, which is calculated in S5, is recorded in the interchange plan recording unit 180.

### <S7, S8>

The SOC acquisition unit 160 acquires the current SOC (corresponding to the amount of stored power) of each of the EVs 10 in S7, and records the current SOC of each of the EVs 10 acquired in S7 in the interchange plan recording unit 180 in S8.

### <S9>

In S9, the interchange plan creation unit 170 calculates the sum of the power consumption amount of all the EVs 10 necessary for the next day calculated in S5 (power consumption sum) and the sum of the current SOC of all the EVs 10 acquired in S7 (current SOC sum).

### <S10, S11>

In S10, the interchange plan creation unit 170 compares the power consumption sum and the current SOC sum calculated in S9. If the current SOC sum is smaller than the power consumption sum (Yes in S11), the processing proceeds to S12, and if the current SOC sum is larger than the power consumption sum (No in S11), the processing proceeds to S13.

### <S12>

In S12, in which the current SOC sum is smaller than the power consumption sum, the interchange plan creation unit 170 reads the charging priority of each of the EVs 10 for the next day from the use schedule storage unit 110, and determines an interchange plan for how much power is to be transferred from one EV 10 to another EV 10 with a policy of transferring (supplying) power from an EV 10 having lower priority to an EV 10 having higher priority such that the EV 10 having higher priority after charging has an SOC as close as possible to the power consumption amount necessary for the next day.

In the case of S12, since the current SOC sum is small, there is a high possibility that the amount of power that can be transferred (supplied) is limited. Even in this case, the interchange plan is created so as to preferentially supply power to the EV 10 having higher priority as much as possible.

### <S13>

In S13, in which the current SOC sum is larger than the power consumption sum, the interchange plan creation unit 170 determines an interchange plan for how much power is transferred from one EV 10 to another EV 10.

Even in S13, similarly to S12, in consideration of the priority, the interchange plan may be created with a policy of transferring (supplying) power from an EV 10 having lower priority to an EV 10 having higher priority such that the EV 10 having higher priority after charging has an SOC as close as possible to the power consumption amount necessary for the next day.

In the case of S13, since the current SOC sum is large, there is a higher possibility that interchange can be performed while the power consumption amount necessary for the next day is left even for the EV 10 having lower priority, than in the case of S12.

### <S14>

In S14, the interchange plan creation unit 170 records the interchange plan determined in S12 or S13 in the interchange plan recording unit 180.

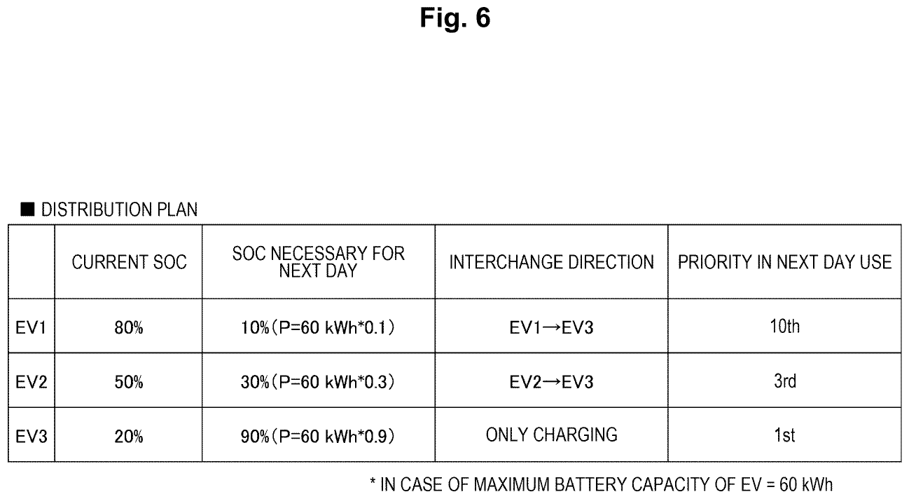

FIG. 6 illustrates an example of an interchange plan (which may also be referred to as a distribution plan) recorded in the interchange plan recording unit 180. FIG. 6 illustrates an interchange plan among the EV 1, the EV 2, and the EV 3.

The example illustrated in FIG. 6 assumes that the maximum battery capacity of each EV is 60 kWh. The EV 3 has the highest priority, and the SOC necessary for the next day is 90% (P=60 kwh×0.9). Since the current SOC is 20%, it is determined that it is necessary to receive power supply from another EV.

For the EV 1, the SOC necessary for the next day is 10% (P=60 kwh×0.1), the current SOC is 80%, and there is power to spare. Therefore, it is determined that “power is supplied from the EV 1 to the EV 3”. In addition, for the EV 2, the SOC necessary for the next day is 30% (P=60 kwh×0.3), the current SOC is 50%, and there is power to spare even in this case. Therefore, it is determined that “power is supplied from the EV 2 to the EV 3”.

More specifically, in the case of the example of FIG. 6, in order to cover the amount of power required by the EV 3 having the highest priority for the next day and not to hinder the use of the EV 1 or the EV 2, the interchange plan creation unit 170 determines, for example, to supply the amount of power corresponding to the SOC 60% from the EV 1 to the EV 3 and to supply the amount of power corresponding to the SOC 10% from the EV 2 to the EV 3.

In the example of FIG. 6, for example, if the margin (amount of additionally required power) for the EV 3, is the SOC 10%, the SOC necessary for the next day is 100% (P=60 kwh×1). In this case, the interchange plan creation unit 170 determines, for example, to supply the amount of power corresponding to the SOC 70% from the EV 1 to the EV 3 and to supply the amount of power corresponding to the SOC 10% from the EV 2 to the EV 3.

### <S15>

In S15, the interchange execution unit 190 reads the interchange plan from the interchange plan recording unit 180, and causes the interchange execution system 40 to perform interchange among the EVs 10. As an example, in a case where power interchange is executed from the EV 1 to the EV 3, the interchange execution unit 190 instructs the charge/discharge device connected to the EV 1 to discharge power from the EV 1, and instructs the charge/discharge device connected to the EV 3 to charge the EV3 with the discharged power. For example, when detecting that the SOC of the EV 3 has reached the planned SOC, the interchange execution unit 190 instructs the charge/discharge device to stop discharging and charging.

### [Another Configuration Example]

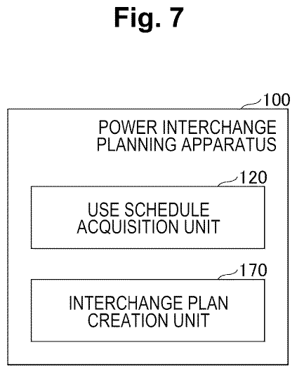

The configuration of the power interchange planning apparatus 100 is not limited to the configuration illustrated in FIG. 1. For example, as illustrated in FIG. 7, the power interchange planning apparatus 100 may have a configuration including the use schedule acquisition unit 110 and the interchange plan creation unit 170.

The power interchange planning apparatus 100 is a device that creates a plan for performing power interchange among a plurality of electric mobile devices.

The use schedule acquisition unit 110 acquires a use schedule of each of the electric mobile devices. The interchange plan creation unit 170 calculates a future power consumption amount of each of the electric mobile devices on the basis of the use schedule, and generates a power interchange plan among the plurality of electric mobile devices on the basis of the power consumption amount and an amount of power stored in each of the electric mobile devices.

### (Hardware Configuration Example)

The power interchange planning apparatus 100 described in the present embodiment can be implemented, for example, by causing a computer to execute a program. This computer may be a physical computer or may be a virtual machine on the cloud.

That is, the power interchange planning apparatus 100 can be implemented by a program corresponding to processing performed by the power interchange planning apparatus 100 being executed with hardware resources such as a CPU and a memory built in the computer. The above program can be stored and distributed by being recorded in a computer-readable recording medium (a portable memory or the like). In addition, the above program can also be provided through a network such as the Internet or an electronic mail.

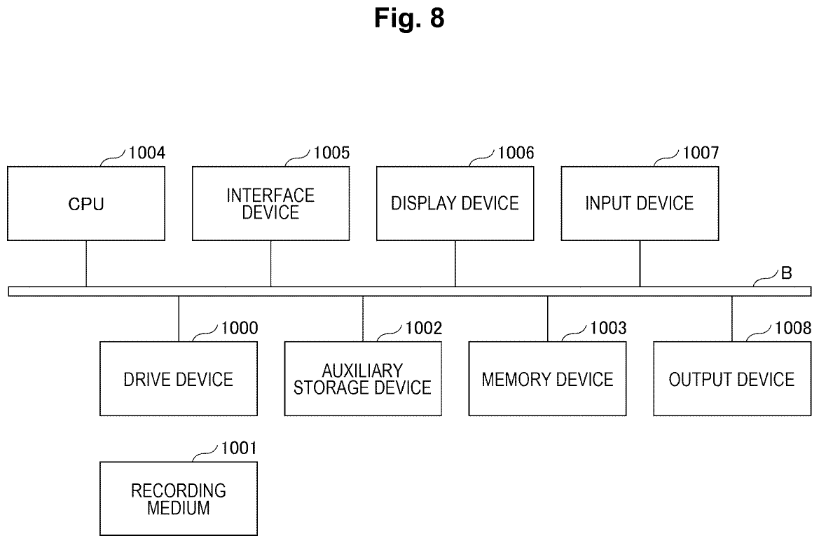

FIG. 8 is a diagram illustrating a hardware configuration example of the above computer. The computer in FIG. 8 includes a drive device 1000, an auxiliary storage device 1002, a memory device 1003, a CPU 1004, an interface device 1005, a display device 1006, an input device 1007, an output device 1008, and the like, which are connected to each other via a bus BS. Note that the computer may further include a GPU.

The program for implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002, and stores the program. The CPU 1004 implements a function related to the power interchange planning apparatus 100 in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, a button, a touch panel, or the like, and is used to input various operation instructions. The output device 1008 outputs a calculation result.

### Summary of Embodiment, Effects, and Like

As described above, according to the technology described in the present embodiment, power interchange based on a use schedule for the next day makes it possible to improve the renewable energy utilization rate without hindering the use of EVs.

With regard to the above embodiment, the following supplementary notes are further disclosed.

### SUPPLEMENTARY NOTES

### Supplementary Note 1

A power interchange planning apparatus that creates a plan for performing power interchange among a plurality of electric mobile devices, the power interchange planning apparatus including:
a memory; and
at least one processor connected to the memory,
wherein
the processor
acquires a use schedule of each of the electric mobile devices,
calculates a future power consumption amount of each of the electric mobile devices based on the use schedule, and creates a power interchange plan among the plurality of electric mobile devices based on the power consumption amount and an amount of power stored in each of the electric mobile devices.

### Supplementary Note 2

The power interchange planning apparatus according to supplementary note 1, wherein
the power consumption amount includes a margin corresponding to fluctuation of the power consumption amount.

### Supplementary Note 3

The power interchange planning apparatus according to supplementary note 2, wherein
a margin at a certain travel distance is larger than a margin at a travel distance smaller than the travel distance.

### Supplementary Note 4

The power interchange planning apparatus according to any one of supplementary notes 1 to 3, wherein
priority is given to the plurality of electric mobile devices, and the processor creates the power interchange plan based on the priority.

### Supplementary Note 5

The power interchange planning apparatus according to any one of supplementary notes 1 to 4, further including
an interchange execution unit that instructs a charge/discharge device connected to at least one of the plurality of electric mobile devices to perform power interchange based on the power interchange plan.

### Supplementary Note 6

A power interchange planning method executed by a power interchange planning apparatus that creates a plan for performing power interchange among a plurality of electric mobile devices, the power interchange planning method including:
a use schedule acquisition step of acquiring a use schedule of each of the electric mobile devices; and
a plan creation step of calculating a future power consumption amount of each of the electric mobile devices based on the use schedule, and creating a power interchange plan among the plurality of electric mobile devices based on the power consumption amount and an amount of power stored in each of the electric mobile devices.

### Supplementary Note 7

A non-transitory storage medium storing a program for causing a computer to function as each unit in the power interchange planning apparatus according to any one of supplementary notes 1 to 5.

Although the present embodiment has been described above, the present invention is not limited to such a specific embodiment, and various modifications and changes can be made within the scope of the gist of the present invention described in the claims.

Reference Signs List

| | |
|---|---|
| 10 | EV |
| 20 | Charge/discharge device |
| 30 | PV device |
| 40 | Interchange execution system |
| 100 | Power interchange planning apparatus |
| 110 | Use schedule storage unit |
| 120 | Use schedule acquisition unit |
| 130 | SOC fluctuation acquisition unit |
| 140 | Interchange policy determination unit |
| 150 | Margin addition unit |
| 160 | SOC acquisition unit |
| 170 | Interchange plan creation unit |
| 180 | Interchange plan recording unit |
| 190 | Interchange execution unit |
| 1000 | Drive device |
| 1001 | Recording medium |
| 1002 | Auxiliary storage device |
| 1003 | Memory device |
| 1004 | CPU |
| 1005 | Interface device |
| 1006 | Display device |
| 1007 | Input device |
| 1008 | Output device |

1. An apparatus that creates a plan for performing power interchange among a plurality of electric mobile devices, the apparatus comprising:
a processor; and
a memory that includes instructions, which when executed, cause the processor to execute:
creating a power interchange plan among the plurality of electric mobile devices based on a future power consumption amount of each of the electric mobile devices and an amount of power stored in each of the electric mobile devices.

2. The apparatus according to claim 1, wherein
the power consumption amount includes a margin corresponding to fluctuation of the power consumption amount.

3. The apparatus according to claim 2, wherein
a margin at a certain travel distance is larger than a margin at a travel distance smaller than the certain travel distance.

4. The apparatus according to claim 1, wherein
priority is given to each of the plurality of electric mobile devices, and
the creating includes creating the power interchange plan based on the priority.

5. The apparatus according to claim 1, wherein the instructions, which when executed, further cause the processor to execute:
instructing a charge/discharge device connected to at least one of the plurality of electric mobile devices to perform power interchange based on the power interchange plan.

6. A power interchange planning method executed by an apparatus that creates a plan for performing power interchange among a plurality of electric mobile devices, the power interchange planning method comprising:
creating a power interchange plan among the plurality of electric mobile devices based on a future power consumption amount of each of the electric mobile devices and an amount of power stored in each of the electric mobile devices.

7. A non-transitory computer-readable recording medium having computer-readable instructions stored thereon, which when executed, cause a computer to execute the power interchange planning method according to claim 6.

8. The apparatus according to claim 1, wherein the instructions, which when executed, further cause the processor to execute:
calculating the future power consumption amount of each of the electric mobile devices based on a use schedule of each of the electric mobile devices.
